(19) United States
(12) Patent Application Publication
(10) Pub. No.: US 2023/0375733 A1
(43) Pub. Date: Nov. 23, 2023

(54) SYSTEMS AND METHODS FOR PREDICTING LITHOLOGY CHARACTERISTICS FROM SEISMIC DATA OF BEDFORMS

(71) Applicant: ExxonMobil Technology and Engineering Company, Spring, TX (US)

(72) Inventors: Juan J. FEDELE, Spring, TX (US); David C. HOYAL, Houston, TX (US)

(21) Appl. No.: 18/307,285

(22) Filed: Apr. 26, 2023

Related U.S. Application Data
(60) Provisional application No. 63/342,871, filed on May 17, 2022.

(51) Int. Cl. G01V 1/28; G01V 1/30; E21B 49/00

(52) U.S. Cl. CPC G01V 1/282; G01V 1/306; E21B 49/00; E21B 2200/20

(57) ABSTRACT

Methods for assessing lithology characteristics of bedforms within or relating to a subterranean formation using seismic data may include: assigning a bedform type to a bedform; extracting a cross-section of seismic data along the bedform in-line +/−15° with a fluid flow direction associated with the bedform; analyzing the cross-section to ascertain a structural characteristic of the bedform, wherein the structural characteristic comprises one or more of: a wavelength, a wave height, a bedform slope, a bedform asymmetry, a bedform migration, and a planform crest shape; and estimating a lithology for the bedform based on a correlation between (a) the lithology and (b) the bedform type and the structural characteristic.

### CROSS-REFERENCE TO RELATED APPLICATION

This application claims the benefit of U.S. Provisional Application Ser. No. 63/342,871, entitled “SYSTEMS AND METHODS FOR PREDICTING LITHOLOGY CHARACTERISTICS FROM SEISMIC DATA OF BEDFORMS,” filed May 17, 2022, the disclosure of which is hereby incorporated by reference in its entirety.

### FIELD OF INVENTION

The present disclosure relates to methods and systems for assessing lithology characteristics of bedforms within or relating to a subterranean formation using seismic data.

### BACKGROUND

In hydrocarbon exploration, development, and/or production stages, different types of data are acquired and utilized to create subsurface models. The subsurface models may be used to represent the subsurface structures, which may include a description of subsurface structures and material properties for a subsurface region. The measured or interpreted data for the subsurface region may be utilized to create the subsurface model and/or to refine the subsurface model. For example, a subsurface model may represent measured or interpreted data for the subsurface region, such as seismic data and well log data, and may have material properties, such as rock properties. As another example, a subsurface model may be used to simulate flow of fluids within the subsurface region. Hybrids of the foregoing may also be used as subsurface models. Accordingly, the subsurface models may include different scales to lessen the computations for modeling or simulating the subsurface within the model.

Well logs may be utilized to provide data for the subsurface region. Further, core samples may be obtained for analysis. In particular, the analysis of core samples may involve determining detailed flow data for the individual core samples, which may involve obtaining measurements from the core samples. Methods like nuclear magnetic resonance (NMR) imaging and computed tomography (CT) imaging are often used to ascertain characteristics of the core samples like fluid make-up (e.g., percent gas, percent oil, percent water), porosity, and permeability. Unfortunately, the data collection and analysis may be time-consuming and expensive.

### SUMMARY OF INVENTION

The present disclosure relates to methods and systems for assessing lithology characteristics of bedforms within or relating to a subterranean formation using seismic data.

A nonlimiting example method of the present disclosure comprises: assigning a bedform type to a bedform; extracting a cross-section of seismic data along the bedform in-line plus or minus (+/−) 15° with a fluid flow direction associated with the bedform; analyzing the cross-section to ascertain a structural characteristic of the bedform, wherein the structural characteristic comprises one or more of: a wavelength, a wave height, a bedform slope, a bedform asymmetry, a bedform migration, and a planform crest shape; and estimating a lithology for the bedform based on a correlation between (a) the lithology and (b) the bedform type and the structural characteristic.

Another nonlimiting example method of the present disclosure comprises: assigning a bedform type to a bedform; extracting a cross-section of seismic data along the bedform in-line +/−15° with a fluid flow direction associated with the bedform; analyzing the cross-section to ascertain a structural characteristic of the bedform, wherein the structural characteristic comprises one or more of: a wavelength, a wave height, a bedform slope, a bedform asymmetry, a bedform migration, and a planform crest shape; and estimating a grain size characteristic for the bedform based on a correlation between (a) the grain size characteristic and (b) the bedform type and the structural characteristic.

System for carrying out said methods may comprise: a processor; a memory coupled to the processor; and instructions provided to the memory, wherein the instructions are executable by the processor to cause a system to perform either of the foregoing methods.

These and other features and attributes of the disclosed methods and systems of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings. The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 illustrates a seabed with a variety of bedforms.

FIG. 2 illustrates a channel bedform transitioning into a lobe bedform along with a fluid flow direction relative to the two bedforms.

FIG. 3A illustrates a nonlimiting example of a seismic cross-section of a contour current bedform.

FIG. 3B is a trace-line for the surface of the cross-section of seismic data of FIG. 3A illustrating the wavelength and height measurements.

FIG. 3C is a trace-line for the surface of the cross-section of seismic data of FIG. 3A illustrating the bedform slope measurement.

FIG. 4 is a graphical representation of a correlation between the bedform structural characteristics, the bedform type, and a grain size characteristic.

FIG. 5 is a graphical representation of a correlation between the bedform structural characteristics, the bedform type, and a lithology.

### DETAILED DESCRIPTION

Bedforms are depositional features that develop as a result of granular material being moved and deposited by fluid flow. The surface morphologies of bedforms may indicate the flow characteristics or flow types for the fluid thereabove. Two example flow types are turbidity currents and bottom currents. Turbidity currents are sediment-laden subaqueous, ephemeral flows that generally have high velocities and large sediment loads, which under certain flow and sediment conditions are able to develop large (seismic-scale) bedforms, observed typically to migrate up-slope. Bottom currents are density driven persistent flows, part of the oceanic internal circulation, which also can develop large bedforms in pre-existing sedimentary deposits under particular flow conditions. The characteristics of the flow above the surface of a bedform also influences the coarseness of the particulate matter that can be deposited and moved within the fluid flow.

Over time, layers and layers of particulate matter are deposited. The coarseness of the particulate matter influences the lithology of the formation as well as the connectivity and porosity of the formation. The lithology, connectivity, permeability, and porosity, in turn, may influence the hydrocarbon exploration, development, and/or production activities. For example, a low porosity and low connectivity subterranean formation may be approached from a hydrocarbon exploration, development, and/or production point of view than a low porosity and high connectivity subterranean formation or than a high porosity and high connectivity subterranean formation.

Current methods for ascertaining lithology, connectivity, permeability, and porosity characteristics of a subterranean formation often include procuring and analyzing core samples, which can be expensive and time consuming, especially in deep-water environments. The systems and methods described herein utilize seismic data to analyze the structural characteristics of a bedform(s) that correspond to the subterranean formation and estimate the coarseness of the particulates (or grain size characteristics) that formed the bedform(s). The grain size characteristics may then be used to estimate lithology, connectivity, permeability, and porosity of the bedform(s) and, consequently, subterranean formation.

In some instances, bedforms may become compacted over time. Described herein are systems and methods that may be useful in decompacting the seismic data to an estimated sedimentation bedform structure, which can be used for deriving grain size characteristics and estimate porosity and/or connectivity of the bedform(s) and, consequently, subterranean formation.

Typically, seismic data is procured for subterranean formations as a regular course of hydrocarbon exploration, development, and/or production. The systems and methods described herein advantageously analyzed said data in a different manner to estimate certain features (porosity and/or connectivity) of the subterranean formation without the requirement of collecting core samples.

The term “rock-type fraction” is defined as the ratio of the rock volume containing a specific rock-type that to the total (gross) rock volume. As such, the gross rock volume can be divided into 2 components: (1) rock volume containing a specific rock-type, and (2) rock volume containing all other rock types. So, rock-type fraction may be expressed as:

$$rock type fraction = \frac{volume of a specific rock type}{total rock volume}$$

An example of a rock-type fraction is v-shale (volume shale), typically calculated from electronic well log measurements and sometimes inferred from seismic data. Rock type may include geologically defined term (e.g., shale, granite, sandstone) or may be a customized defined type. Using the expression for rock-type fraction:

$${v}_{shale} = \frac{volume of shale}{total rock volume}$$

The term “net-to-gross”, also denoted N:G, as used herein includes the term v-shale (volume shale, or vₛₕₐₗₑ). The relationship between v-shale and net-to-gross may be expressed as follows:

N:G=1−νₛₕₐₗₑ (when a 0 to 1 value scale is used)

N:G=(1−νₛₕₐₗₑ)*100 (when a percentage value scale is used)

Furthermore, whenever the term “net-to-gross” or “N:G” is used herein, it is understood that this is an example of a rock-type fraction, and that any other choice of rock-type fraction may be selected.

As used herein, the term “permeability” is defined as the ability of a rock to transmit fluids through interconnected pores in the rock.

As used herein, the term “porosity” is defined as the percent volume of pore space in a rock. Total or absolute porosity includes all the pore spaces, whereas effective porosity includes only the interconnected pores.

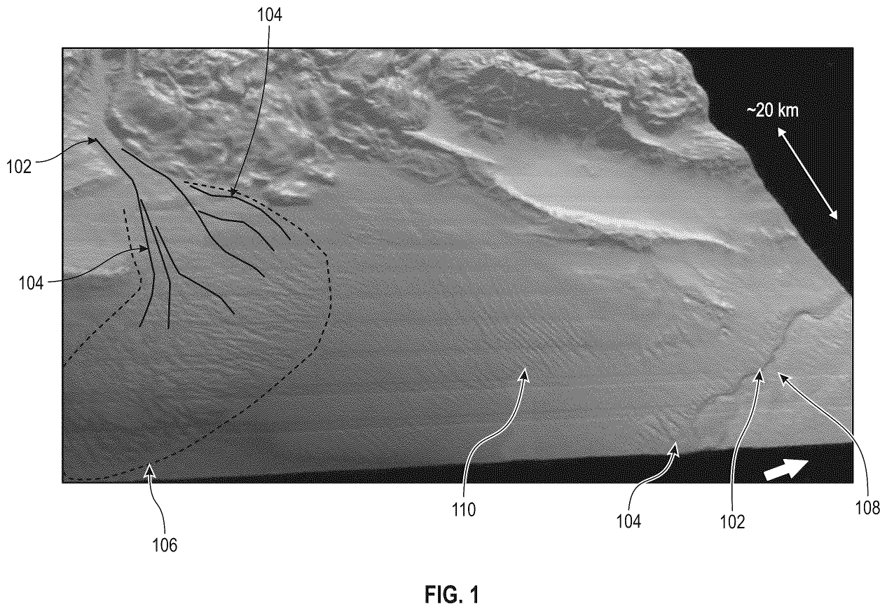

A bedform type may be described based on the surface shape, structure, and confinement of the bedform. FIG. 1 illustrates a seabed with a variety of bedforms. Examples of bedform types include, but are not limited to, channel bedforms 102, lobe bedforms 104, fan bedforms 106, levee bedforms 108, contour current bedforms 110, and transitions from one shape to another. Without being limited by theory, the bedform types may be characterized and/or identified based on, for example, surface shape (or outline), particulate deposition structures, and fluid flow confinement. Channels may have confined fluid flow with primarily turbidity currents. Channels generally have some depths and walls that confine the fluid flow. At the top of the walls, levees may be like plateaus. Along the levees, the flow is less to not confined (e.g., unconfined or poorly confined), which provides a surface appearance similar to fans and/or contour current shapes described below. As the confinement of the fluid flow decrease from the channels, the surface shape may widen and the walls may dissipate, which produces lobe shapes. The lobes may be have mounds of sediment with bottom currents flow near the top of the mound and more turbid currents between mounds (but not to the turbid extent in channels). Then, as flow becomes less confined, the shape expands laterally (hence the name fan), and waves of sediment form along the surface due primarily to bottom currents, but that are directional because of the upstream confined flows. The other surface shape described herein is contour current, which is a portion of the surface that has very little to no confinement (like a plain) and primarily bottom currents form waves of sediment along the surface whose crests are generally perpendicular to the fluid flow direction. Over time, more layers of particulate material may sediment on top of these bedforms and compress lower sediment layers.

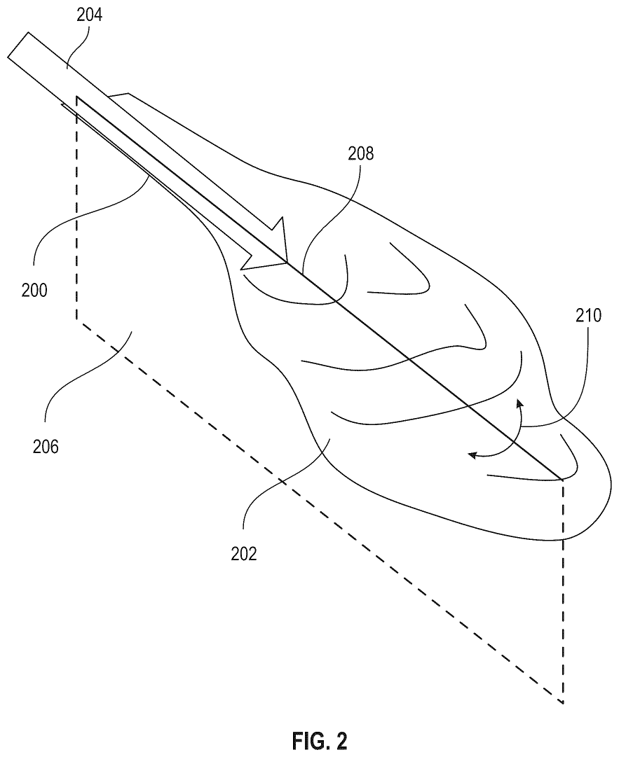

The methods described herein analyze the structural characteristics of a cross-section of seismic data along the bedform in the fluid flow direction. FIG. 2 illustrates a channel bedform 200 transitioning into a lobe bedform 202 along with a fluid flow direction 204 relative to the two bedforms 200, 202. The seismic data analyzed in the methods and systems described herein is a cross-section 206 extending into the formation at least substantially in-line 208 with the fluid flow direction 204. The cross-section 206 may be along a line that is in-line with the fluid flow direction 204 +/−15° (or +/−10°).

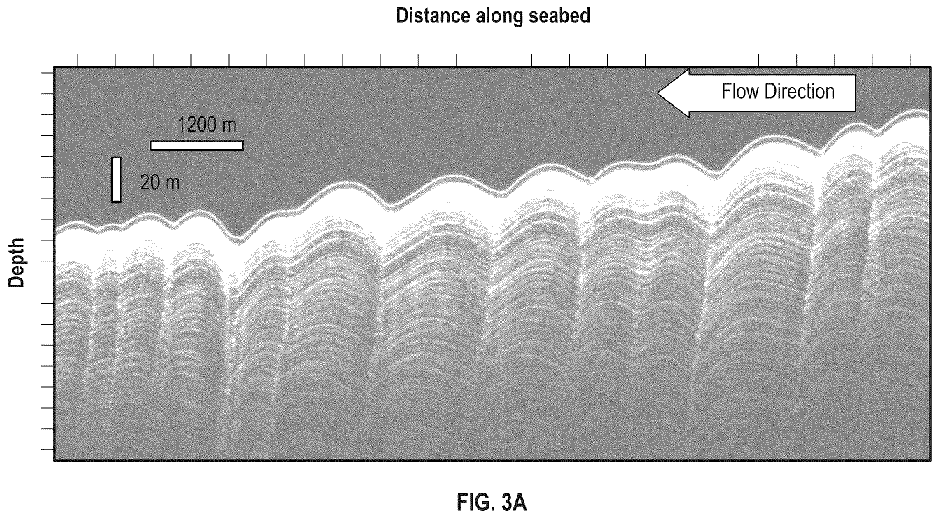

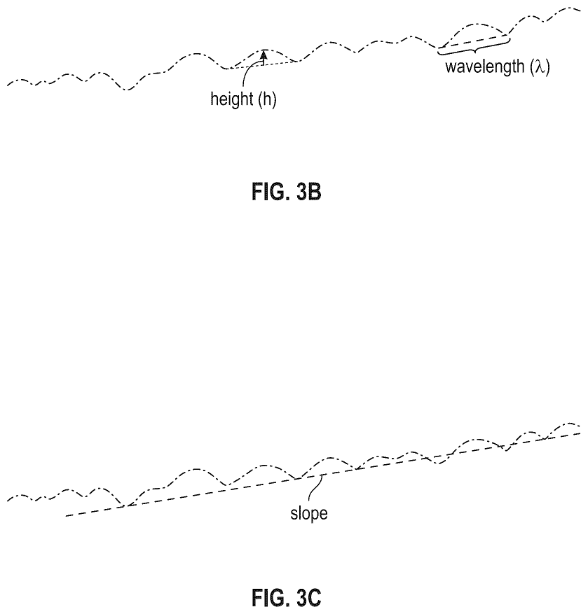

FIG. 3A illustrates a nonlimiting example of a seismic cross-section of a contour current bedform. Again, the seismic cross-section is at least substantially in-line with the fluid flow direction. The seismic cross-section illustrates the waves of sediment along the surface that are generally perpendicular to the fluid flow direction.

The structural characteristics of a cross-section of seismic data along the bedform in the fluid flow direction may include one or more of: a wavelength, a wave height, a bedform slope, a bedform asymmetry, a bedform migration, and a planform crest shape.

FIG. 3B is a trace-line for the surface of the cross-section of seismic data of FIG. 3A illustrating the wavelength and height measurements. The wavelength (λ) is the distance from valley-to-valley along the trace-line. The height (h) is the largest distance extending perpendicular for the valley-to-valley line defining wavelength to the trace-line. Image analysis software may be used to identify the line used to measure the wavelength and height. Multiple measurements in a single cross-section and over several cross-sections are preferably measured to determine a characteristic (e.g., a mean average, a mode average, a median average, or other suitable method) value for the wavelength and height.

FIG. 3C is a trace-line for the surface of the cross-section of seismic data of FIG. 3A illustrating the bedform slope measurement. To determine slope, a line is drawn to interest (or come close to) each of the valleys. Image analysis software may be used to identify the line used to measure the bedform slope. Several cross-sections are preferably measured to determine a characteristic (e.g., a mean average, a mode average, a median average, or other suitable method) value for the bedform slope. If possible, the slope line should be drawn approximately perpendicular to the bedform crests, if a method is available to identify the features in planform.

Bedform asymmetry describes to the peak structures within along the trace-line. A symmetric structure has a peak near the center (within about the central 20%) between the two valleys. An asymmetric structure has a peak closer to one of the neighboring two valleys. An upslope asymmetry is the peak being closer to the upper of the two valleys. A downslope asymmetry is the peak being closer to the lower of the two valleys. In the FIG. 3A example, the bedform asymmetry is asymmetric.

Bedform migration whether the direction of the slope is relative to the fluid flow direction. In the FIG. 3A example, the bedform migration is upslope, but not to a large degree.

Planform crest shape describes the general shape of the trace-line from end-to-end, which spans hundreds of feet. Examples of planform crest shape include crescentic (a long mound), upslope concavity (a long valley), sinuous (wavy), and straight (little curvature). In the FIG. 3A example, the planform crest shape is sinuous.

For the bedform asymmetry, bedform migration, and planform crest shape several cross-sections are preferably analyzed to determine the proper characterization of the bedform. Image analysis software may be used to assist one or more of these analyses.

Over time, bedforms can be compressed as more particulate material is deposited thereon. Decompaction methods (e.g., equations) may be applied to the bedform structural characteristics. Of the bedform structural characteristics, the wave height may be the most effected by compression. The decompaction method or equation applied may depend on the rock-type (e.g., sand vs shale). In the example shown here, a porosity decompaction was used, from which a corrected vertical height of the bedform can be derived. There are other methods that may be used to obtain a corrected vertical length after decompaction. The purpose is to estimate a (decompacted) height of the bedform, which can then be used in the methods and systems presented herein.

The bedform type along with one or more structural characteristics (preferably decompacted for depths greater than about 10 meters) of a cross-section of seismic data along the bedform in the fluid flow direction may be used to correlate the bedform to a grain size characteristic and/or lithology. The characteristic grain size may be a specific grain size, a range of grain sizes, or a characteristic grain type (which is defined by grain size). Examples of characteristic grain types include, but are not limited to, mud (about 50 microns or less), silt (about 50 microns to about 62 microns), sand (about 62 microns to about 500 microns), and coarse particulate (about 500 microns or greater). Within a characteristic grain type about 50 weight percent (wt %) or volume percent (v %) or greater of the particulate material may fall within the characteristic size range. As further examples, the characteristic grain type may be about 60 wt % or greater (or 60 v % or greater) or about 75 wt % or greater (or 75 v % or greater) of the particulate material may fall within the characteristic size range. It should be noted that within the mud ranges, the particles transported during deposition may be larger than the clay primary particles due to clay flocculation. In such occasions, methods for grain size analysis from the samples destroy the particles (clay flocs) as they were naturally transported and deposited forming the large muddy sediment waves.

The lithology may be described, for example, by rock-type (e.g., sandstone, shale, or limestone), rock-type fraction (e.g., v-shale), net-to-gross, or any combination thereof.

Correlations between (a1) the grain size characteristic and (b1) the bedform type and the structural characteristic and/or (a2) the lithology and (b2) the bedform type and the structural characteristic may be determined empirically. For example, data from water tanks where particulate material, fluid flow, and slope may be controlled may be used to simulate the formation of bedforms and ascertain the structural characteristics. Further, in-field data (e.g., seafloor studies) where flow characteristics are known may also be used. Additionally, data may be simulated. Any combination of the foregoing may be used to ascertain a correlation. The examples provided herein include suitable correlations that may be used. Correlations may be refined over time as additional data is available.

Correlations may be equations, graphs, or other suitable correlation representations.

The grain size characteristics and/or lithology may be used in a plurality of ways to inform hydrocarbon exploration, development, and/or production. For example, the grain size characteristics and/or lithology may be used to estimate (values or ranges or generalities relating to) for formation permeability, porosity, connectivity, or a combination thereof.

In another example, the grain size characteristics and/or the lithology may be input to a subsurface model used during exploration, development, and/or production of hydrocarbons. Examples of subsurface models and the use of lithologies therein is described in U.S. Pat. No. 7,844,430, incorporated herein by reference.

Methods of the present disclosure may include performing a wellbore operation that is, at least in part, informed or otherwise based on the grain size characteristics and/or lithology described herein or values or models derived therefrom. At least some of the operational parameters for a wellbore operation performed on the formation may be informed or otherwise based on the grain size characteristics and/or lithology. At least some of the operational parameters for a wellbore operation performed on the formation may be informed or otherwise based on the formation permeability, porosity, connectivity, or a combination thereof derived from the grain size.

Examples of wellbore operations may include, but are not limited to, drilling operations, stimulation operations (e.g., fracturing operations, acidizing operations, propping operations, flooding operations, and the like), production operations, and the like.

The methods described herein can, and in many embodiments must, be performed using computing devices or processor-based devices. “Computer-readable medium” or “non-transitory, computer-readable medium,” as used herein, refers to any non-transitory storage and/or transmission medium that participates in providing instructions to a processor for execution. Such a medium may include, but is not limited to, non-volatile media and volatile media. Non-volatile media includes, for example, NVRAM, or magnetic or optical disks. Volatile media includes dynamic memory, such as main memory. Common forms of computer-readable media include, for example, a floppy disk, a flexible disk, a hard disk, an array of hard disks, a magnetic tape, or any other magnetic medium, magneto-optical medium, a CD-ROM, a holographic medium, any other optical medium, a RAM, a PROM, and EPROM, a FLASH-EPROM, a solid state medium like a memory card, any other memory chip or cartridge, or any other tangible medium from which a computer can read data or instructions. When the computer-readable media is configured as a database, it is to be understood that the database may be any type of database, such as relational, hierarchical, object-oriented, and/or the like. Accordingly, exemplary embodiments of the present systems and methods may be considered to include a tangible storage medium or tangible distribution medium and prior art-recognized equivalents and successor media, in which the software implementations embodying the present techniques are stored.

The methods described herein can, and in many embodiments must, be performed using computing devices or processor-based devices that include a processor; a memory coupled to the processor; and instructions provided to the memory, wherein the instructions are executable by the processor to perform the methods described herein (such computing or processor-based devices may be referred to generally by the shorthand “computer”).

Similarly, any calculation, determination, or analysis recited as part of methods described herein may be carried out in whole or in part using a computer.

Furthermore, the instructions of such computing devices or processor-based devices can be a portion of code on a non-transitory computer readable medium. Any suitable processor-based device may be utilized for implementing all or a portion of embodiments of the present techniques, including without limitation personal computers, networks, laptop computers, computer workstations, mobile devices, multi-processor servers or workstations with (or without) shared memory, high performance computers, and the like. Moreover, embodiments may be implemented on application specific integrated circuits (ASICs) or very large scale integrated (VLSI) circuits.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

### ADDITIONAL EMBODIMENTS

Embodiment 1. A method comprising: assigning a bedform type to a bedform; extracting a cross-section of seismic data along the bedform in-line +/−15° with a fluid flow direction associated with the bedform; analyzing the cross-section to ascertain a structural characteristic of the bedform, wherein the structural characteristic comprises one or more of: a wavelength, a wave height, a bedform slope, a bedform asymmetry, a bedform migration, and a planform crest shape; and estimating a lithology for the bedform based on a correlation between (a) the lithology and (b) the bedform type and the structural characteristic.

Embodiment 2. The method of Embodiment 1, wherein the analyzing of the cross-section comprises: decompacting a portion of the cross-section at least 10 meters below a subsea surface to yield decompacted seismic data, wherein the structural characteristic is based on the decompacted seismic data.

Embodiment 3. The method of Embodiment 1 or 2 further comprising: modeling a subterranean formation comprising the bedform with a subsurface model using the lithology as an input to the subsurface model.

Embodiment 4. The method of Embodiment 3 further comprising: performing a wellbore operation based on the subsurface model.

Embodiment 5. The method of Embodiment 1 or 2 further comprising: estimating a porosity, permeability, connectivity, or any combination thereof based on the lithology.

Embodiment 6. The method of Embodiment 5 further comprising: modeling a subterranean formation comprising the bedform with a subsurface model using the lithology and the porosity, permeability, connectivity, or any combination as an input to the subsurface model.

Embodiment 7. The method of Embodiment 6 further comprising: performing a wellbore operation based on the subsurface model.

Embodiment 8. The method of any of Embodiments 1 to 7, wherein the analyzing of the cross-section uses image analysis software.

Embodiment 9. A system comprising: a processor; a memory coupled to the processor; and instructions provided to the memory, wherein the instructions are executable by the processor to cause a system to perform the method of any of Embodiments 1 to 8.

Embodiment 10. A method comprising: assigning a bedform type to a bedform; extracting a cross-section of seismic data along the bedform in-line +/−15° with a fluid flow direction associated with the bedform; analyzing the cross-section to ascertain a structural characteristic of the bedform, wherein the structural characteristic comprises one or more of: a wavelength, a wave height, a bedform slope, a bedform asymmetry, a bedform migration, or a planform crest shape; and estimating a grain size characteristic for the bedform based on a correlation between (a) the grain size characteristic and (b) the bedform type and the structural characteristic.

Embodiment 11. The method of Embodiment 10, wherein the analyzing of the cross-section comprises: decompacting a portion of the cross-section at least 10 meters below a subsea surface to yield decompacted seismic data, wherein the structural characteristic is based on the decompacted seismic data.

Embodiment 12. The method of Embodiment 10 or 11 further comprising: modeling a subterranean formation comprising the bedform with a subsurface model using the grain size characteristic as an input to the subsurface model.

Embodiment 13. The method of Embodiment 12 further comprising: performing a wellbore operation based on the subsurface model.

Embodiment 14. The method of Embodiment 10 or 11 further comprising: estimating a porosity, permeability, connectivity, or any combination thereof based on the grain size characteristic.

Embodiment 15. The method of Embodiment 14 further comprising: modeling a subterranean formation comprising the bedform with a subsurface model using the grain size characteristic and the porosity, permeability, connectivity, or any combination as an input to the subsurface model.

Embodiment 16. The method of Embodiment 15 further comprising: performing a wellbore operation based on the subsurface model.

Embodiment 17. The method of any of Embodiments 10 to 16, wherein the analyzing of the cross-section uses image analysis software.

Embodiment 18. A system comprising: a processor; a memory coupled to the processor; and instructions provided to the memory, wherein the instructions are executable by the processor to cause a system to perform the method of any of Embodiments 10 to 17.

To facilitate a better understanding of the embodiments of the present invention, the following examples of preferred or representative embodiments are given. In no way should the following examples be read to limit, or to define, the scope of the invention.

### EXAMPLES

### Example 1

Data from a plurality of seafloor studies were compiled. The data included seismic data, seafloor images, and formation lithology and/or grain size data. Analysis was performed on the seismic data to ascertain bedform structural characteristics including average wavelength, average wave height, and average bedform slope. The seafloor images were analyzed to ascertain the type of bedform and, consequently, a characteristic confinement of the fluid flow. Table 1 provides a list of the correlation between type of bedform and characteristic confinement of the fluid flow.

TABLE 1

| Fluid Flow Confinement | |
|---|---|
| Description | Type of Bedform |
| I: Unconfined | Contour current bedforms |
| | Levees |
| II: Moderately Confined | Fan bedforms |
| | Lobe bedforms |
| | Channel-to-lobe transition bedforms |
| III: Confined | Channel bedforms |

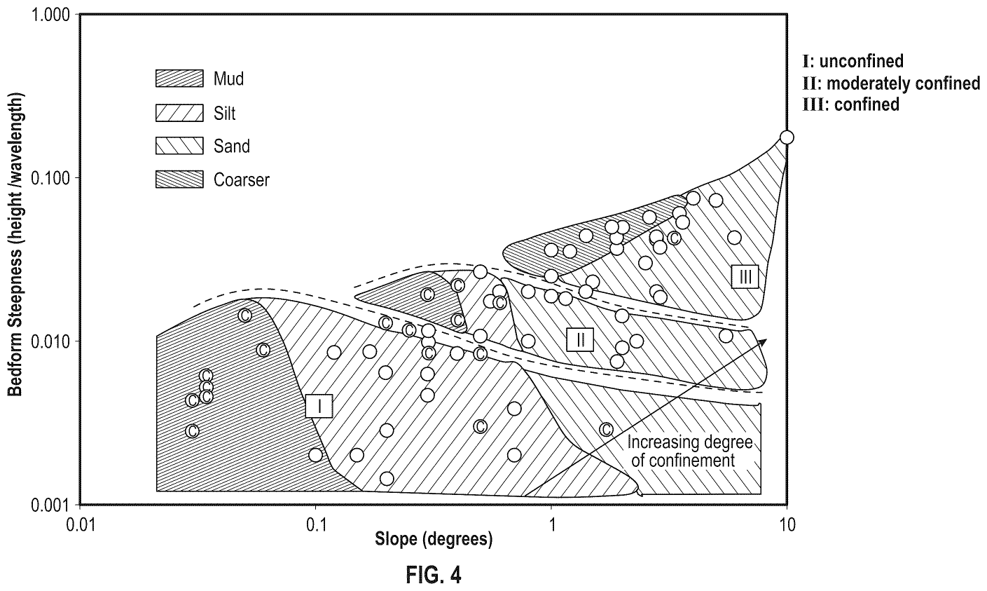

FIG. 4 is a graphical representation of a correlation between the bedform structural characteristics, the bedform type, and a grain size characteristic. FIG. 4 is a plot of bedform steepness (wave height divided by wavelength) as a function of bedform slope (in degrees). Overlaid on the graph are dashed lines indicating a demarcation between the three different fluid flow confinement descriptions. These demarcations were drawn based on separating data points falling into each description. Further overlaid on the graph are zones that illustrate the grain size data separated into four categories: mud, silt, sand, and coarse. FIG. 4 is a nonlimiting example of a correlation that may be used when analyzing new formations to ascertain the grain size characteristics.

### Example 2

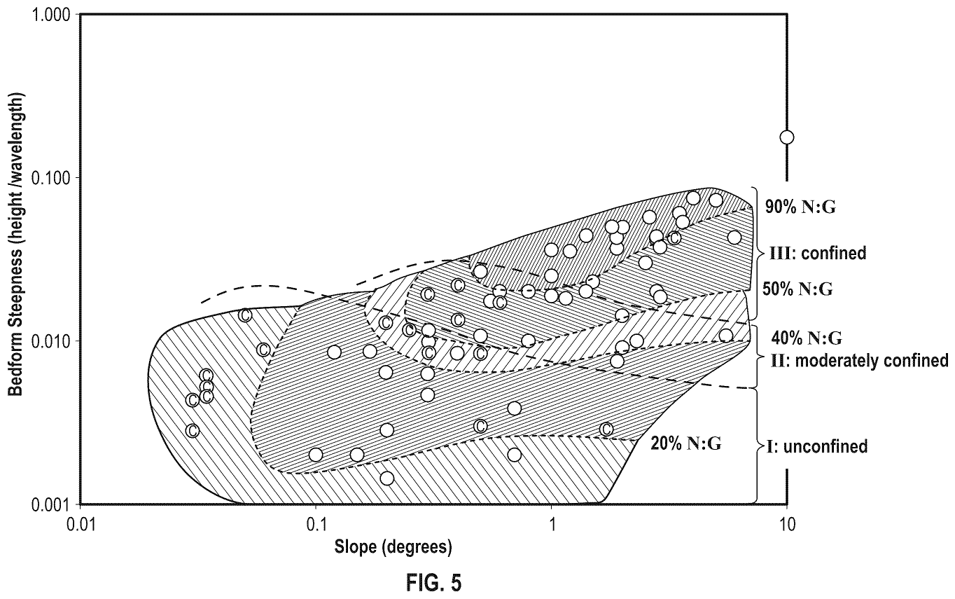

The data from Example 1 was used to correlate lithology (specifically N:G) to bedform structural characteristics. FIG. 5 is a graphical representation of a correlation between the bedform structural characteristics, the bedform type, and a lithology (specifically N:G). FIG. 5 is a plot of bedform steepness (wave height divided by wavelength) as a function of bedform slope (in degrees). Overlaid on the graph are the three different fluid flow confinement descriptions from Example 1. Further overlaid on the graph are zones bounded by N:G values. Like the confinement descriptions, the N:G zones bounds were based on the data in the seafloor studies. FIG. 4 is a nonlimiting example of a correlation that may be used when analyzing new formations to ascertain the lithology (specifically N:G).

Therefore, the present invention is well adapted to attain the ends and advantages mentioned as well as those that are inherent therein. The particular examples and configurations disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A method comprising:
assigning a bedform type to a bedform;
extracting a cross-section of seismic data along the bedform in-line +/−15° with a fluid flow direction associated with the bedform;
analyzing the cross-section to ascertain a structural characteristic of the bedform, wherein the structural characteristic comprises one or more of: a wavelength, a wave height, a bedform slope, a bedform asymmetry, a bedform migration, and a planform crest shape; and
estimating a lithology for the bedform based on a correlation between (a) the lithology and (b) the bedform type and the structural characteristic.

2. The method of claim 1, wherein the analyzing of the cross-section comprises:
decompacting a portion of the cross-section at least 10 meters below a subsea surface to yield decompacted seismic data, wherein the structural characteristic is based on the decompacted seismic data.

3. The method of claim 1 further comprising:
modeling a subterranean formation comprising the bedform with a subsurface model using the lithology as an input to the subsurface model.

4. The method of claim 3 further comprising:
performing a wellbore operation based on the subsurface model.

5. The method of claim 1 further comprising:
estimating a porosity, permeability, connectivity, or any combination thereof based on the lithology.

6. The method of claim 5 further comprising:
modeling a subterranean formation comprising the bedform with a subsurface model using the lithology and the porosity, permeability, connectivity, or any combination as an input to the subsurface model.

7. The method of claim 6 further comprising:
performing a wellbore operation based on the subsurface model.

8. The method of claim 1, wherein the analyzing of the cross-section uses image analysis software.

9. A system comprising:
a processor;
a memory coupled to the processor; and
instructions provided to the memory, wherein the instructions are executable by the processor to cause a system to:
assign a bedform type to a bedform;
extract a cross-section of seismic data along the bedform in-line +/−15° with a fluid flow direction associated with the bedform;
analyze the cross-section to ascertain a structural characteristic of the bedform, wherein the structural characteristic comprises one or more of: a wavelength, a wave height, a bedform slope, a bedform asymmetry, a bedform migration, and a planform crest shape; and
estimate a lithology for the bedform based on a correlation between (a) the lithology and (b) the bedform type and the structural characteristic.

10. A method comprising:
assigning a bedform type to a bedform;
extracting a cross-section of seismic data along the bedform in-line +/−15° with a fluid flow direction associated with the bedform;
analyzing the cross-section to ascertain a structural characteristic of the bedform, wherein the structural characteristic comprises one or more of: a wavelength, a wave height, a bedform slope, a bedform asymmetry, a bedform migration, and a planform crest shape; and
estimating a grain size characteristic for the bedform based on a correlation between (a) the grain size characteristic and (b) the bedform type and the structural characteristic.

11. The method of claim 10, wherein the analyzing of the cross-section comprises:
decompacting a portion of the cross-section at least 10 meters below a subsea surface to yield decompacted seismic data, wherein the structural characteristic is based on the decompacted seismic data.

12. The method of claim 10 further comprising:
modeling a subterranean formation comprising the bedform with a subsurface model using the grain size characteristic as an input to the subsurface model.

13. The method of claim 12 further comprising:
performing a wellbore operation based on the subsurface model.

14. The method of claim 10 further comprising:
estimating a porosity, permeability, connectivity, or any combination thereof based on the grain size characteristic.

15. The method of claim 14 further comprising:
modeling a subterranean formation comprising the bedform with a subsurface model using the grain size characteristic and the porosity, permeability, connectivity, or any combination as an input to the subsurface model.

16. The method of claim 15 further comprising:
performing a wellbore operation based on the subsurface model.

17. The method of claim 10, wherein the analyzing of the cross-section uses image analysis software.

18. A system comprising:
a processor;
a memory coupled to the processor; and
instructions provided to the memory, wherein the instructions are executable by the processor to cause a system to:
assign a bedform type to a bedform;
extract a cross-section of seismic data along the bedform in-line +/−15° with a fluid flow direction associated with the bedform;
analyze the cross-section to ascertain a structural characteristic of the bedform, wherein the structural characteristic comprises one or more of: a wavelength, a wave height, a bedform slope, a bedform asymmetry, a bedform migration, and a planform crest shape; and
estimate a grain size characteristic for the bedform based on a correlation between (a) the grain size characteristic and (b) the bedform type and the structural characteristic.
